(19) United States
(12) Patent Application Publication
(10) Pub. No.: US 2009/0177498 A1
(43) Pub. Date: Jul. 9, 2009

(54) System and Method for Developing Loss Assumptions

(76) Inventors: Dieter S. Gaubatz, Fort Wayne, IN (US); Edward J. Wright, Fort Wayne, IN (US)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/035,882

(22) Filed: Feb. 22, 2008

Related U.S. Application Data
(63) Continuation of application No. 11/968,996, filed on Jan. 3, 2008.

(51) Int. Cl. G06Q 40/00

(52) U.S. Cl. 705/4

(57) ABSTRACT

A method for developing assumptions for use in evaluating the possible occurrence of an event comprises the steps of defining a plurality of factors correlated with each other to the event, assigning a plurality of levels to each factor, determining a relative occurrence rate for selected combinations of factors and levels, and assigning selected combinations to one of a plurality of cohorts. In certain embodiments, the method, and a corresponding system are used in designing an insurance product. The method may include the additional steps of assigning values to the levels and evaluating expected performance of the product based upon the values assigned to the levels and the expected loss distribution. The step of producing an expected loss distribution includes determining, for at least some of the selected combinations, a cumulative probability of occurrence, and determining, for at least one of the selected combinations, an incremental probability of occurrence.

### RELATED APPLICATIONS

The present application is a continuation patent application which is related to and claims priority to U.S. Divisional patent application Ser. No. 11/968,996 filed Jan. 3, 2008; which is related to and claims priority to U.S. patent application Ser. No. 10/291,301 filed Nov. 8, 2002 which claims priority to U.S. Provisional Patent Application Ser. No. 60/334,261, filed on Nov. 29, 2001, all entitled System and Method for Developing Loss Assumptions. The subject matter disclosed in said utility and provisional applications is hereby expressly incorporated into the present application.

### FIELD OF INVENTION

This invention relates generally to risk management and, more specifically to the field of financial products. More particularly, this invention relates to systems and methods for developing and assessing assumptions used in designing and pricing financial products, including insurance products.

### BACKGROUND AND SUMMARY OF THE INVENTION

The pricing of insurance products is difficult because the pricing must be done before the product is sold, but must reflect results that will not be known for some time after the product has been bought and paid for. With tangible products, “the cost of goods sold” is known before the product is sold because the product is developed from raw materials which were acquired before the product was developed. With insurance products, this is not the case. The price of the coverage is set and all those who buy the coverage pay the premium dollars. Subsequently, claims are paid to the unfortunate few who experience a loss. If the amount of claims paid is greater than the amount of premium dollars collected, then the insurer will make less than their expected profit and possibly lose money. If the insurer has been able to predict the amount of claims to be paid and has collected the right amount of premiums, then the insurer will be profitable.

The price of an insurance product is determined from a set of assumptions related to expected losses, expenses, investments, etc. Generally, the largest amount of money paid out by an insurer is in the payment of claims for loss. Since the actual amounts will not be known until the future, insurers make assumptions about what the losses will be. If the actual claims payments are less than or equal to the predicted claims payment, then the product will be profitable. If the actual claims are greater than the predicted claims in the assumptions set in pricing, then the product will not be profitable and the company will lose money. Hence, the ability to set assumptions for the expected losses is critical to the success of the product. The present invention has been developed to assist in this process of developing and assessing assumptions for pricing insurance products.

An insurer must develop a set of assumptions which reflect the probabilities of occurrence of the loss being insured, the probability of the number of people who will lapse the coverage (that is, stop paying their premiums), and other financial elements such as expenses, interest rates and taxes. Insurers use historical data on losses to help them predict what future losses will be. Professionals with experience in mathematics and statistics called actuaries develop tables of losses that incorporate the rate of loss for the group over time into cumulative loss rates. These tables of cumulative loss rates are the bases for pricing insurance products.

In pricing a specific product, an actuary starts with the basic loss tables. Then, based upon judgments concerning the specific nature of the table, the risk to which it is applied, the design of the product, the risk selection techniques applied at the time the policy is issued, and other factors, the actuary develops a set of assumptions for the cumulative loss rates to serve as the foundation for the expected future claims of the product.

Depending upon the specific insurance product being developed, the historical data and the loss tables do not always correlate well with the specific risks which the policy will cover. For example, most life insurance mortality tables deal with the average probability of death in an insured population. However, some insurance products are directed to sub-groups in a population. Mortality may vary in these sub-groups. For example, some healthier people have a mortality which is preferred, that is, better than the average mortality. In order to price products for such people, actuaries must be able to segment the cumulative loss rate from the standard mortality tables into cohorts to tease out the mortality of those who are objectively healthier within the standard group, and to develop assumptions on these more specific subsets of the population.

Segmenting these cumulative loss rates requires that the actuary understand the risk factors for loss which characterize the general insured population versus the risk factors which signal the subset with preferred mortality. For example, in life insurance, people with no medical conditions and a blood pressure measurement at the high end of the normal range may have standard mortality, while those with a blood pressure measurement at the lower end of the normal range may have preferred mortality, i.e., a lower mortality rate.

However, the standard loss tables do not take into consideration these separate risk factors. Actuaries must research other sources of data, such as medical or epidemiological studies to determine loss rates of specific populations and the risk factors which are correlated with them. Then, in the process of pricing a product which differentiates price based upon the risk factors, the actuary must set assumptions as to how these risk factors correlate with the cumulative loss rates in the loss table. Going back to the previous example, if the product is sold to healthy individuals with a blood pressure in the lower end of the normal range, the actuary must make an assumption of how much less than the standard mortality the mortality rate will be for this subset to determine the premium price for this subset of people.

Further, in the creative design of products, actuaries will have to develop the appropriate assumptions of loss in which there may be multiple risk factors, each one, individually or in combination with other factors, derived from different studies and loss tables.

Certain embodiments of the present invention allows the user to take individual, or various combinations of risk factors and associated loss rates from different studies, and use these risk factors and loss rates to unbundle the components of cumulative loss in the loss tables. Some embodiments further allow the user to create new relationships among the risk factors, and determine new cumulative loss rates reflecting the new sets of risk factors.

The present invention has multiple applications. New insurance products can be designed with a large number of risk factors, all of which can be correlated as to their contribution to a cumulative loss rate. A wide range of existing and new types of product designs and specifications can be accurately correlated with the loss assumptions used in actually pricing an insurance product by analyzing the involved risk factors in a positive or negative manner. This invention also helps to define the pricing implications of making exceptions in accepting risks which may not have all of the risk factors in line with those used in setting the assumptions.

One embodiment of the present invention comprises a method for developing loss assumptions for use in designing an insurance product. The method comprises steps of defining a plurality of factors correlated to an insurable event, assigning to each factor a plurality of levels indicative of possible states of occurrence, assigning values to each of the levels, producing an expected loss distribution for selected combinations of the factors and levels, and evaluating the expected performance of the insurance product based upon the values assigned to the levels and the expected loss distribution. In one embodiment, the expected loss distribution is produced by the steps of determining, for the selected combinations of factors and levels, an incremental probability of occurrence of each combination in a population, and determining, for these selected combinations, a loss rate. This loss rate reflects the factors present at the time the policy is issued. There are significant correlation effects with the presence of various combinations of factors. The expected loss distribution is the product of these two quantities.

The step of evaluating the expected performance of the insurance product may comprise the step of evaluating an expected loss rate of the product, an expected market share to be obtained by the product, and/or other aspects of the product. In one embodiment, at least one of the values assigned to the levels is adjusted based upon the evaluation, and the expected performance of the product is re-evaluated based upon the adjusted levels.

Certain embodiments of the invention further include the steps of defining a plurality of cohorts with each cohort representing a range of incremental probabilities of occurrence of the insurable event.

Another embodiment of the invention is a method for developing loss assumptions for use in designing an insurance product for a population of risks comprising the steps of defining a plurality of factors correlated to an insurable event, assigning to each factor a plurality of levels indicative of possible states of occurrence of the factor in the population, determining, for selected combinations of factors and levels, a loss distribution based upon an incremental probability of occurrence of the combination in the population and a respective loss rate and assigning the selected combinations to one of a plurality of cohorts. One embodiment comprises the additional steps of assigning values to each of the levels, and evaluating the expected performance of the insurance product based upon the values assigned to the levels and the expected loss distribution. The step of evaluating the expected performance of the insurance product comprises the step of evaluating an expected loss rate for the product, an expected market share to be obtained by the product, and/or other aspects of the product. One embodiment of the invention comprises the additional step of adjusting at least one of the values assigned to the levels based upon the evaluation of the expected performance of the insurance product. The product may be re-evaluated with the adjusted values and additional adjustments to the values may be made, as desired.

The present invention may be used in connection with financial products other than insurance products, such as mortgages, loans and similar products. Accordingly, one embodiment of the invention is a method for developing assumptions for use in designing such products. This embodiment comprises the steps of defining a plurality of factors correlated to an event, characteristic, feature or other aspect of the financial product, assigning a plurality of levels to each factor indicative of possible states of occurrence of the factor in a population, assigning values to each of the levels, determining, for selected combinations of factors and levels, a distribution based upon an incremental probability of occurrence of the combination in the population, and evaluating the expected performance of the financial product based upon the values assigned to the levels in the distribution. In the case of a mortgage, for example, factors may include income level, price range of the property, term, credit rating of the mortgagee, etc. Each of these and/or other factors may be assigned a plurality of levels indicative of possible states of occurrence of such factors in a population.

In one embodiment, the step of evaluating the expected performance of a financial product may include the step of evaluating an expected loss rate for the product or evaluating an expected market share to be obtained by the product. One embodiment further comprises the additional step of adjusting at least one of the values assigned to each of the levels based upon the evaluation of the expected performance of the financial product. One or more of the values may be adjusted, and the product may be re-evaluated, as desired.

More broadly, the subject invention may be used for managing risk by developing assumptions for use in evaluating the possible occurrence of an event. One embodiment includes a method for managing such risk, comprising the steps of defining a plurality of factors correlated to the event, assigning a plurality of levels to each factor, assigning values to each of the levels, determining, for selected combinations of factors and levels, a probability distribution based upon an incremental probability of occurrence of the combination in the population and a relative occurrence rate and assigning the selected combinations to one of a plurality of cohorts.

Other advantages and novel features of the present invention will become apparent from the following detailed description of the invention when considered in conjunction with the accompanying drawings.

### BRIEF DESCRIPTION OF THE DRAWINGS

FIG. 1 illustrates the manner in which levels and values are assigned to a plurality of factors which are correlated to an insurable event, and which are considered in developing loss assumptions for use in the design of an insurance product.

FIG. 2 illustrates the manner in which a table may be constructed within the system to account for all possible combinations of factors and levels selected for use in the design of an insurance product.

FIG. 3 illustrates a three-dimensional version of a cumulative probability of occurrence matrix.

FIG. 4 illustrates a three-dimensional version of a cumulative mortality ratio matrix.

### DETAILED DESCRIPTION OF EMBODIMENTS OF THE INVENTION

The present invention relates to systems and methods for use in risk management.

An application of the present invention is the design and pricing of financial products. A more specific application of the present invention relates to systems and methods for designing and pricing insurance products. The particular embodiments of the invention described in detail below include a system and method for developing and assessing assumptions used in the design and pricing of insurance products.

A loss assumption is a statement relating, directly or indirectly, to an insurable event which is taken to be true. The design and price of an insurance product is determined, in large part, from a set of such assumptions. Loss assumptions may be expressed in numerical terms. With respect to factors which have been shown by experience to be correlated with the occurrence of an insurable event, the relationship between a factor and the insurable event and/or other factors can be quantified. Quantification allows for the use of statistical and other mathematical techniques to be brought to bear in the development of assumptions underlying the design and pricing of a particular insurance product.

For purposes of illustration, much of the following discussion is specific to life insurance as a specific category of insurance product, and mortality as a specific category of risk. However, it should be clearly understood that the system(s) and method(s) disclosed are applicable in other product and risk categories. Thus, the present disclosure should not be construed as limited in any way to the particular field of life insurance or mortality.

Specifically, the systems and methods of the present invention can be used in any field in which a decision must be made, and in which a plurality of factors can be identified as being correlated with the occurrence of an event or condition related to the decision. For example, in the design of a mortgage (or other type of loan product), decisions must be made as to interest rate, points payable in advance, maximum loan amounts, loan default rates and other factors. The loan default rate may be influenced by factors specific to each transaction, such as the income/asset level of a prospective borrower, the type of property, prevailing market conditions, risk tolerance of the lender, and other factors. The systems and methods of the present invention may be used to design a mortgage product and/or to facilitate the decision process in transactions involving such product. Other examples will be readily apparent to those of skill in the art of risk management and decision making in the presence of risk.

### Life Insurance Example

In the design and pricing of life insurance products, insurers define risk classifications or “bands” into which members of an insurable population can be placed. Defining the effects on the loss (mortality) rate of various combinations of risk classifications (i.e., banding or stratifying the risk) is an actuarial function. Evaluating the risk of a specific individual or risk to determine which classification the individual or risk fits in is an underwriting function.

In the case of a specific risk (e.g., an individual life in the life insurance context), it is generally impossible to determine exactly when an insurable event will occur. However, insurers can develop a risk profile for an individual risk which may be used to determine how likely an occurrence of the insurable event is at a particular time. Risk profiles are developed on the basis of factors which are both quantifiable and verifiable. In the case of life insurance, blood pressure, cholesterol levels, and build are quantifiable and verifiable factors which may be used to develop a risk profile. In the design and pricing of a life insurance product, an insurer makes assumptions as to the relative impacts of such factors on mortality, and creates risk classifications and pricing structures based upon these assumptions.

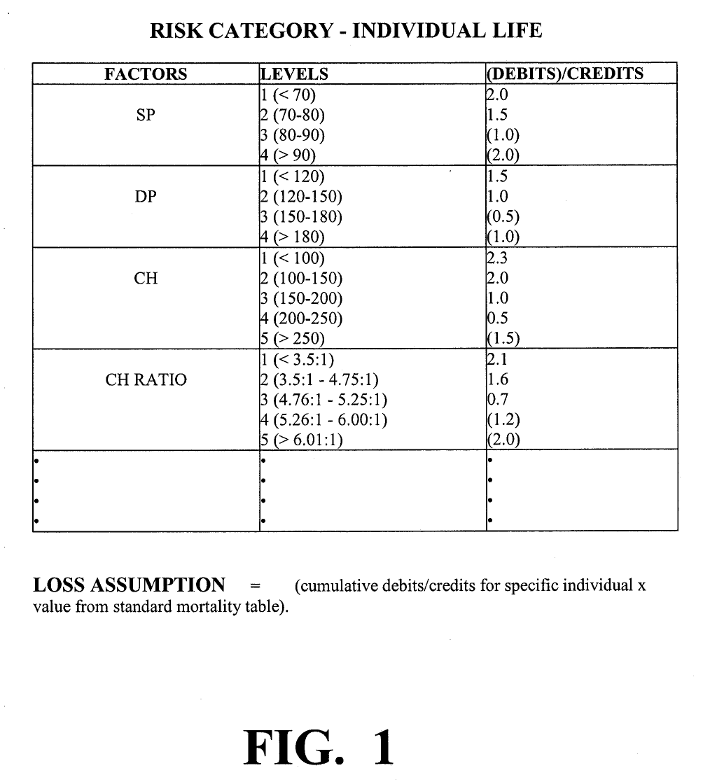

The present invention facilitates the development of risk classifications or “cohorts” in the design of an insurance product. FIG. 1 illustrates the manner in which one embodiment of the method and system of the present invention is used in the context of life insurance. In this embodiment, the first step is defining a plurality of factors that are correlated to the insurable event. In the particular example illustrated in FIG. 1, these are listed in the column titled FACTORS as SP (systolic blood pressure), DP (diastolic blood pressure), CH (cholesterol level), and CH RATIO (cholesterol ratio). There are additional factors (e.g., build, motor vehicle record, family history, past medical history, and hobbies) which may be considered, as well. It is not unusual to consider as many as twelve to fifteen factors. However, it is also possible to use a lesser or greater number of factors (such as, two or forty). In the system and method of the present invention, an insurer or other client for whom a product is being developed can specify which and how many factors are to be used, and the levels at which individuals qualify under each factor. In some instances, one or more factors may be highly correlated with one another. In such instances, use of both factors is somewhat redundant and has only a limited impact upon the process of defining risk classifications or cohorts. Use of this system and method facilitates evaluation and selection of factors by insurers or other clients.

The next step in the process as illustrated in FIG. 1 is assigning levels to each of the factors. This is illustrated in FIG. 1 in the column titled LEVELS. The number of levels listed and the associated values and ranges are illustrative only. More (or fewer) levels may be used and the values and ranges associated therewith may be varied. However, an aspect of the present invention is that the levels are chosen and associated with the expected ranges in a manner which is non-cumulative. That is, the applicable population (and its associated mortality) is spread over the levels, as opposed to each successive level being inclusive of all preceding levels. For example, with reference to factor SP, mortality for a population may be spread over levels 1, 2, 3 and 4 in the example of FIG. 1 as 15%, 35%, 40% and 10%, respectively, rather than cumulatively as 15%, 50%, 90% and 100%. This distinction is discussed in additional detail below.

The next step in the process as illustrated in FIG. 1 is assigning values (in this case, debits and credits) to each of the levels. This is illustrated in FIG. 1 in the column titled (DEBITS)/CREDITS by appropriately weighting the values assigned to each of the levels and factors. The relative impact of each level and factor may be adjusted to finely tune the system for use in the actuarial process of defining risk classifications, as well as in the underwriting process of evaluating specific risks. This approach further facilitates accounting for interrelationships among the various factors. For example, the debits assigned to an individual having a high cholesterol may be at least partially (and incrementally) offset by credits resulting from a favorable cholesterol ratio, blood pressure or build factor. Assigning numerical values to the various levels facilitates consideration of such interrelationships, particularly in the environment of digital processing.

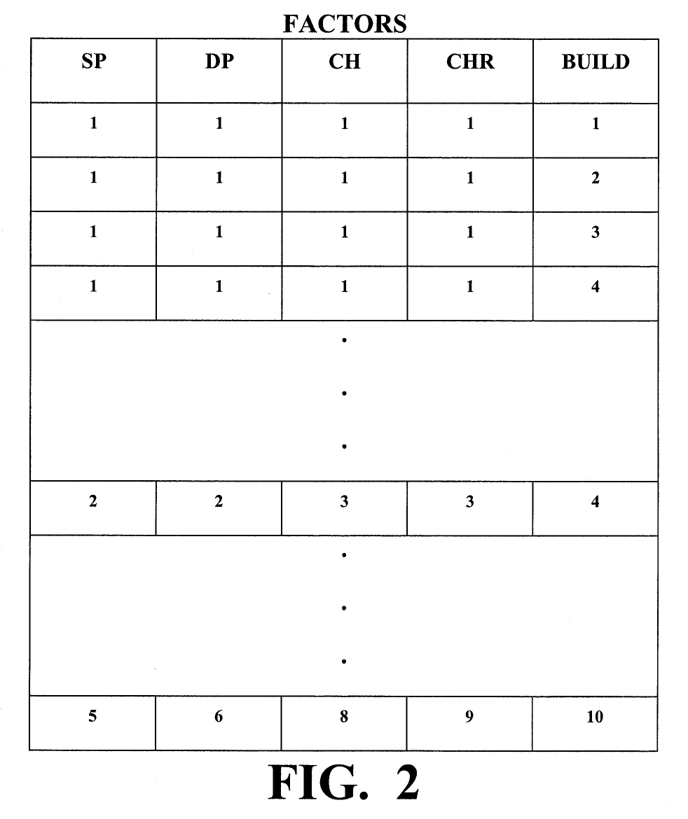

The user of the system (e.g., an insurer or the designer of an insurance product for an insurer) is usually involved in the selection of factors, designation of levels, and assignment of values in the process described thus far. Indeed, in some cases, an insurer who will be offering the product in the market place will have the primary role in this regard. In addition to the insurer's own knowledge base, beliefs and preferences concerning the relative impacts of the various factors and levels on mortality, other considerations may dictate or influence the choice of factors and levels, and the relative values assigned to the levels. For example, an insurer may choose, for competitive reasons, to emphasize (or de-emphasize) certain factors. A product may be designed, at least in part, to achieve a certain market share in a given population. The choice of factors, levels and values may also be impacted by the existence of other competitive products in the market. FIG. 2 illustrates the manner in which a table may be constructed within the system to account for all possible combinations of factors and levels selected for use in the design of a particular product. In the example of FIG. 2, 5 factors are designated, with the factors having 5, 6, 8, 9 and 10 levels, respectively. Again, the number of factors and levels are illustrative only. Both the number of factors and the number or levels for each factor may be increased or decreased, as desired.

For each of the combinations represented by the rows in FIG. 2, two quantities are determined and entered into the system. The first quantity is a probability of occurrence of each combination within a standard population. The second quantity is a mortality ratio (i.e., the number of observed deaths divided by the number of expected deaths) for each combination. Information regarding these quantities is available from empirical data and research. Much of this information is available in the public literature, while some will be available to insurers based upon their experiences with individuals and groups. For some combinations, the combined judgment of actuaries and other professionals may form the primary basis for one or the other of these two quantities. In any event, as additional information (e.g., studies, research results, experiences with particular groups and individuals, etc.) becomes available, that information may be used to continuously refine these quantities. The product of the probability of occurrence and the mortality ratio is a mortality distribution for all the combinations.

When using large numbers of factors and levels, there will inevitably be combinations for which relatively little information is available from which to determine the probability of occurrence and/or mortality ratio. Thus, there will be “gaps” occurring throughout the table. Interpolation may be used to bridge such gaps. However, simple interpolation may lead to irrational results (i.e., for certain combinations, the system may produce results which are contrary to logic and experience). This result is, for the most part, avoided by use of an incremental (rather than cumulative) approach in determining the mortality distribution for the combinations. As described above in connection with designating the levels of FIG. 1, the mortality distribution for each combination is based on incremental mortality changes (i.e., the “delta”) between various levels, rather than cumulatively as might otherwise be done.

As previously discussed, a probability of occurrence can be determined for each of the combinations illustrated in FIG. 2. These values can be arranged in the form of the matrix having dimensions equal to the number of factors being considered. For instance, the example of FIG. 2 would result in a five dimensional matrix. As also previously discussed, the values representative of probability of occurrence can be presented in two formats, cumulative or incremental. Each of the values in the latter format may be termed “splinters.”

The cumulative matrix provides the values in the form that the probability of occurrence provided is the one that satisfies or exceeds the criterion for each of the factors. The mortality ratio under this approach provides the overall average relative mortality of the group that satisfies or exceeds the criterion for each of the combination of factors. This structure is easier to use when translating research results into the matrix format. However, as the number of combinations of factors and levels increase, it becomes increasingly more difficult to ensure that each of the micro or local relationships between adjacent cells is consistent in all dimensions. As a result, the number of factors that can be included in one cohort is limited. This structure allows for a preferred insurance program where qualification must be based on meeting all criteria, with or without a limited number of possible exceptions.

The incremental or splinter matrix provides the values in the form that the probability of occurrence provided is the one that exactly meets the criterion of each of the combinations. The mortality ratio provides the relative mortality of the group that exactly meets the criteria for all of the specific criteria in that combination of factors. It is easier to work with this format to ensure that all of the relative relationships are consistent. It is also easier to make adjustments to the factors, including the adjustment for varying relationships in different countries. Using this structure, a larger number of factors can be used for each cohort. This approach also makes possible the pricing of a product using debits and credits as the qualifying criteria. “Exception rules” under the “meeting all criteria” approach are simplified.

There is a relationship between the cumulative and splinter formats. That relationship is:

```
Let
  PC_{abc..n} = Cumulative probability value for criteria a, b, c...n
  MC_{abc...n} = Cumulative relative mortality factor for criteria a, b, c...n
  PS_{abc...n} = Splinter probability value for criteria a, b, c...n
  MS_{abc...n} = Splinter relative mortality factor for criteria a, b, c...n
Then
  PC_{abc..n} = Σ(for i = 1, a) Σ(for j = 1, b) Σ(for k = 1, c) ... Σ(for m = 1, n) PS_{ijk...m}
```

| MC_{abc...n} = | I) divided by II), where |
|---|---|
| | I) = Σ(for i = 1, a) Σ(for j = 1, b) Σ(for k = 1, c) ... Σ(for m = 1, n) PS_{ijk...m} |
| | MS_{ijk...m;} |
| | II) = PC_{abc..n} |

PS_{abc...n} = PC_{abc..n}

| | − Σ PC_{(i-p)(j-q)(k-r)...(m-s)} for all combinations of i, j, k...m for all |
|---|---|
| | combinations of p, q, r...s such that one and only one of p, q, r...s = 1 |
| | and all other values of p, q, r...s = 0 |
| | + Σ PC_{(i-p)(j-q)(k-r)...(m-s)} for all combinations of i, j, k...m for all |
| | combinations of p, q, r...s such that two and only two of p, q, r...s = 1 |
| | and all other values of p, q, r...s = 0 |
| | − ... |
| | + (if no. of factors is odd) or − (if no. of factors is even) PC_{(i-1)(j-1)(k-1)...(m-1)} |
| MS_{abc...n} = | I) divided by II), where |
| | ) = (PC_{abc..n} * MC_{abc..n} |
| | − Σ PC_{(i-p)(j-q)(k-r)...(m-s)} * MC_{(i-p)(j-q)(k-r)...(m-s)} for all combinations of |
| | i, j, k...m for all combinations of p, q, r...s such that one and only |
| | one of p, q, r...s = 1 and all other values of p, q, r...s = 0 |
| | + Σ PC_{(i-p)(j-q)(k-r)...(m-s)} * MC_{(i-p)(j-q)(k-r)...(m-s)} for all combinations of |
| | i, j, k...m for all combinations of p, q, r...s such that two and only |
| | two of p, q, r...s = 1 and all other values of p, q, r...s = 0 |
| | − ... |
| | + (if no. of factors is even) or − (if no. of factors is odd)) |
| | PC_{(i-1)(j-1)(k-1)...(m-1)} * MC_{(i-1)(j-1)(k-1)...(m-1))} |
| | II) = PS_{abc...n} |

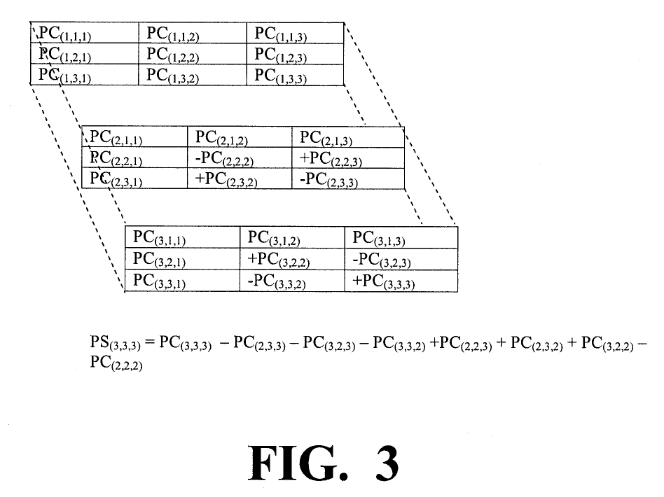

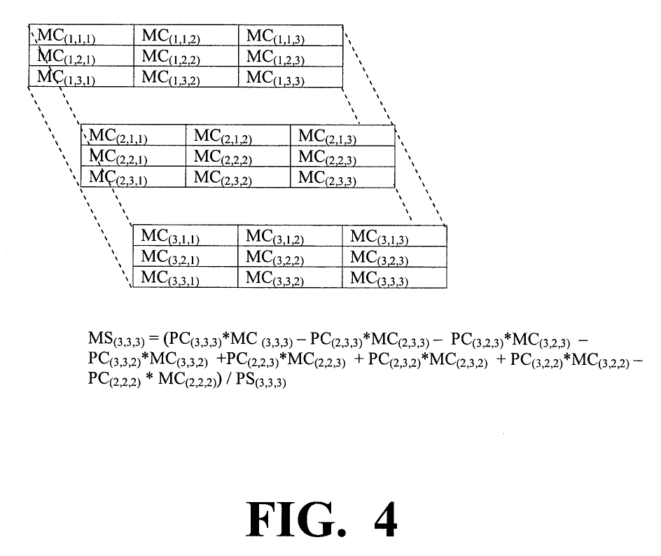

Matrices and dimensions greater than three are inherently hard to visualize. However, a three dimensional version of the cumulative probability of occurrence matrix appears in FIG. 3. FIG. 4 illustrates the corresponding cumulative mortality ratio matrix. In accordance with the above relationships, the corresponding splinter matrices may be derived. An illustrative example of this calculation is:

PS_{(3,3,3)}=PC_{(3,3,3)}−PC_{(2,3,3)}−PC_{(3,2,3)}−PC_{(3,3,2)}+PC_{(2,2,3)}+PC_{(2,3,2)}+PC_{(3,2,2)}−PC_{(2,2,2)}

MS_{(3,3,3)}=(PC_{(3,3,3)}*MC_{(3,3,3)}−PC_{(2,3,3)}*MC_{(2,3,3)}−PC_{(3,2,3)}*MC_{(3,2,3)}−PC_{(3,3,2)}*MC_{(3,3,2)}+PC_{(2,2,3)}*MC_{(2,2,3)}+PC_{(2,3,2)}*MC_{(2,3,2)}+PC_{(3,2,2)}*MC_{(3,2,2)}−PC_{(2,2,2)}*MC_{(2,2,2)})/PS_{(3,3,3)}

Similar calculations can be performed to derive each term of the PS and MS matrices.

The product of the probability and mortality ratio yields a mortality distribution for all possible combinations in the table of FIG. 2. The mortality distribution is used to evaluate the values assigned by the user. This evaluation allows the user to appreciate the consequences of decisions made regarding the factors and levels selected and the values assigned (e.g., the debits/credits of FIG. 1) as they relate to projected pricing and profitability of the product, the market share to be obtained by the product, and other considerations which are of importance in product design. A sensitivity analysis can be performed, if desired, by varying certain of the values assigned to various factors and levels, and determining the manner in which these values impact these considerations. This process allows the user to refine the design of the product to accomplish commercial goals, while having a more complete understanding of the projected performance of the product.

It should be noted that the values assigned to each of the combinations in the table of FIG. 2 may be represented by a numerical quantity (for example, the cumulative debits and credits for each combination). In such an arrangement, the numerical quantities will not necessarily be unique. For example, an individual represented by the combination of 23225 may have the same overall numerical quantity or “score” as an individual represented by the combination 31323. These scores provide the user with a means for drawing “lines” through the multi-dimensional tables to determine which combinations may qualify for particular coverages. If two individuals represented by different combinations have the same score, as referenced above, the overall debits and credits associated with each of these combinations may allow both individuals to qualify for a particular coverage.

It should also be noted that the system will also allow for assigning an alternative value to one of the factors based on one or more of the other levels. For example, an individual represented by a 22125 combination may be viewed differently, with respect to the build factor, than an individual represented by a 44435 combination. A lower (or higher) value may be assigned to build level 5 in the former case, as compared to that assigned in the latter. In other words, the significance of a relatively high “build” factor may be increased when it coincides with relatively high blood pressure and cholesterol levels. Other relationships between the various factors may be similarly addressed.

Throughout this description and the accompanying claims, the terms “correlation” and “correlated” are used (e.g., “a plurality of factors correlated to an insurable event”). These terms are not used in the narrow mathematical sense of a particular second order moment of a probability distribution. Rather, these terms are used in a sense intended to indicate the presence of, or a measure of, the dependence between two or more variables.

Although the invention has been described and illustrated in detail, it is to be clearly understood that the same is intended by way of illustration and example only and is not to be taken by way of limitation. The spirit and scope of the invention are to be limited only by the terms of the appended claims.

1-11. (canceled)

12. A system for developing loss assumptions for use in designing an insurance product, comprising:
a correlation unit configured to correlate a plurality of risk factors with each other to an insurable event;
an assigning unit configured to assign a plurality of levels to each risk factor indicative of possible states of occurrence in a non-cumulative manner, and configured to assign
a plurality of values to the respective levels;
a producing unit configured to produce an expected loss distribution for selected combinations of said risk factors and levels; and
an evaluation unit configured to evaluate the expected performance of the insurance product based upon the values assigned to the levels and the expected loss distribution.

13. The system according to claim 12, wherein the producing unit further comprises:
a first determination unit configured to determine a cumulative probability of occurrence for selected combinations of said risk factors and levels in a population;
a second determination unit configured to determine an incremental probability of occurrence for at least some of said selected combinations of said risk factors and levels in a population; and
a third determination unit configured to determine a loss rate for said selected combinations.

14. The system according to claim 13, wherein the producing unit comprises:
a multiplication unit to multiply the incremental or cumulative probability of occurrence for each of said selected combinations times the respective loss rate.

15. The system of claim 12, wherein the evaluation unit is further configured to evaluate an expected loss rate of the product.

16. The system of claim 12, wherein the evaluation unit is further configured to evaluate an expected market share to be obtained by the product.

17. The system of claim 12, further comprising:
an adjustment unit configured to adjust at least one of the values assigned to each of the levels based upon an evaluation of the expected performance of the insurance product.

18. The system of claim 12, further comprising a plurality of cohorts, each cohort representing a range of incremental probabilities of occurrence of the insurable event.

19. The system of claim 12, further comprising:
an adjustment unit configured to adjust the values assigned to each of the levels and re-evaluating the expected performance of the insurance product.

20. The system of claim 12, wherein the number of said plurality of risk factors is three or more.

21. The system of claim 12, wherein a number of said plurality of risk factors used is between 8 and 64.

22. The system of claim 12, wherein said assigning unit is configured to assign numerical values to each of the respective levels.
